(19) United States
(12) Patent Application Publication
(10) Pub. No.: US 2022/0195612 A1
(43) Pub. Date: Jun. 23, 2022

(54) ELECTROLYSER FOR ELECTROCHLORINATION PROCESSES AND A SELF-CLEANING ELECTROCHLORINATION SYSTEM

(71) Applicant: De Nora Tech, LLC, Concord, OH (US)

(72) Inventors: Anna Ramunni, Milan (IT); Fabio Timpano, Milan (IT)

(21) Appl. No.: 17/551,951

(22) Filed: Dec. 15, 2021

Related U.S. Application Data
(60) Provisional application No. 63/129,075, filed on Dec. 22, 2020.

(51) Int. Cl. C25B 11/093; C25B 9/17; C25B 11/036; C25B 11/063; C25B 1/26; C25B 15/06

(52) U.S. Cl. CPC C25B 11/093; C25B 9/17; C25B 15/06; C25B 11/063; C25B 1/26; C25B 11/036

(57) ABSTRACT

A chlorination electrolyser having a housing provided with an inlet and an outlet suitable for the circulation of brine; at least one pair of bipolar electrodes facing each other and positioned within said housing. Each bipolar electrode of the at least one pair has a valve metal substrate; an active coating comprising at least one layer of a catalytic composition comprising ruthenium and titanium disposed over the substrate; a top coating having at least one layer composed of oxides of tantalum, niobium, tin, or combinations thereof disposed over the active coating. A self-cleaning electrochlorination system having the an electrolyser, a method for its production, its use in normal and low salinity pools for hypochlorite mediated water disinfection and a method for hypochlorite-mediated water disinfection.

### CROSS-REFERENCE TO RELATED APPLICATIONS

This application claims the benefit of U.S. Provisional Application No. 63/129,075 filed on Dec. 22, 2020, the contents of which is incorporated herein by reference.

### FIELD OF THE INVENTION

The invention concerns a chlorination electrolyser operating under polarity reversal conditions, a method for producing the same and a self-cleaning electrochlorination system.

### BACKGROUND OF THE INVENTION

Electrochlorination processes consist in the production of hypochlorite in salt water via an electrolytic reaction. The resulting sodium hypochlorite may be exploited in a variety of applications concerning water disinfection and oxidation, such as water treatment for drinking water, swimming pools or microbiological control in cooling towers.

Sodium hypochlorite is effective against bacteria, viruses and fungi and has the advantage that microorganisms cannot develop resistance to its effects.

Contrary to chlorine gas or tablets, which may be added to water in order to achieve similar results, in electrochlorination processes the active chemical is produced on site, thus avoiding transportation, environmental and/or storage issues. The process is carried out by applying a suitable current to an electrolytic cell comprising at least two electrodes and an electrolyte containing brine, i.e. a mixture of salt and water at varying concentrations depending on the application. The result of the electrochemical reaction is the production of sodium hypochlorite and hydrogen gas.

Titanium electrodes provided with active coating compositions containing mixtures of valve and noble metals, in particular rare transition metals from the platinum group, have been successfully used as anodes in the past in these type of cells. With time, however, the electrode develops scales over its active surface, which negatively impact on the hypochlorite production efficiency of the cell.

In order to prevent/reduce the formation of scales, a periodic polarity inversion can be applied to the electrodes so as to promote their self-cleaning. Reversing the polarity also reduces ion bridging between the electrodes and may prevent uneven electrode wear.

Under polarity reversal conditions, where each electrode works alternately as a cathode and as an anode, some elements occasionally used in the active coating composition become unstable and dissolve in the electrolyte after few inversion cycles, thereby leading to inadequate electrode lifetimes.

In general, polarity reversal is a detrimental operation for the active coating of the electrode, quickly causing its deactivation by delamination.

In order to reduce these issues, it is required to provide the bipolar electrodes used under polarity reversal conditions with much higher coating load than when each electrode is working only as an anode or cathode. In general, electrode durability depends on polarity reversal frequency and on coating load.

Increasing coating load negatively impacts on the cost of the electrodes, both in terms of amount of materials and on a lengthier production process. Furthermore, since many active coating compositions rely on rare transition metals, which present scarce availability, increased loading also worsens any related procurement issues.

It is desirable to have self-cleaning electrodes for electrochlorination systems exhibiting improved lifetimes and efficiency under a wide spectrum of possible applications and operative conditions, and possibly maintaining reduced production costs. It is furthermore desirable to use such electrochlorination systems in normal and low salinity pools, i.e. pools operating at salt levels equal or below 6 g/l (typically 0.5-2.5 g/l NaCl in low salinity and 2.5-4 g/l NaCl in normal salinity applications).

International patent application WO 2019/215944 A1 describes an electrolyzer for ozone generation which is equipped with electrodes having a thick dieletric surface layer in order to increase the oxygen overvoltage for oxygen generation at localized precious metal sites of an intermediate layer. These electrodes are neither suitable for producing chlorine nor for being operated under polarity reversal conditions.

### SUMMARY OF THE INVENTION

The present invention relates to a chlorination electrolyser comprising a housing provided with an inlet and an outlet suitable for the circulation of brine and at least one pair of bipolar electrodes facing each other and positioned within said housing. Each bipolar electrode comprises: (i) a valve metal substrate; (ii) an active coating comprising at least one layer of a catalytic composition comprising ruthenium and titanium disposed over said substrate; (iii) a top coating comprising at least one layer of a composition comprising oxides of tantalum, niobium, tin, or combinations thereof, and positioned over said active coating.

Under another aspect, the present invention relates to a self-cleaning electrochlorination system comprising: (i) the chlorination electrolyser described above; (ii) an electrolyte comprising a 1-30 g/l NaCl brine solution circulating within said electrolyser; (iii) an electronic system for periodically reversing the polarity of the pair of bipolar electrodes electrically connected to the same and positioned outside the housing of the electrolyser.

Under another aspect, the present invention relates to a method for manufacturing the chlorination electrolyser according to the invention.

Under another aspect, the present invention relates to the use of the chlorination electrolyser described above in normal and low salinity pools for hypochlorite mediated water disinfection.

Under still another aspect, the present invention relates to a method for hypochlorite-mediated water disinfection using the chlorination electrolyzer described above under polarity reversal conditions.

### DETAILED DESCRIPTION OF THE INVENTION

Under one aspect, the present invention relates to a chlorination electrolyser comprising:

a housing provided with an inlet and an outlet suitable for the circulation of brine, and at least one pair of bipolar electrodes facing each other and positioned within said housing, where each bipolar electrode of said one pair comprises: (i) a valve metal substrate; (ii) an active coating comprising at least one layer of a catalytic composition comprising ruthenium and titanium disposed over said substrate; (iii) a top coating comprising at least one layer of a composition comprising oxides of tantalum, niobium, tin, or combinations thereof disposed over said active coating.

The at least one layer of a catalytic composition comprising ruthenium and titanium is an essentially homogeneous layer in terms of its electrical properties. The at least one layer of a catalytic composition is also homogeneous in terms of its morphological properties and constitutes essentially a solid solution comprising ruthenium and titanium, preferably a homogeneous solid solution where the metals are predominantly oxides, i.e. ruthenium oxide and titanium oxide.

The chlorination electrolyser according to the invention can be used for hypochlorite mediated water disinfection in a variety of applications, such as pools, waste water disinfection (such as municipal water treatment, black and gray water treatment, seawater chlorination, . . . ).

It may be advantageously operated under polarity reversal conditions, thereby ensuring self-cleaning of the electrodes and avoiding the formation of scales.

Each electrode of the pair may be coated on one or both sides. As customary, the two opposite electrodes should be arranged so as to have the coated sides facing each other.

The chlorination electrolyser may comprise a plurality of bipolar electrode pairs, resulting in a stack of coated electrodes arranged substantially parallel to each other.

The housing shall be designed so as to allow to electrically connect the bipolar electrode pair(s) to an external power generator. The power generator may be advantageously equipped with a system for reversing electrode polarity at a preset frequency, usually in the range of 30 min-10 hours, depending on the application and the operative conditions, such as water contaminants and water hardness, as well known in the field.

The valve metal substrate may be of any geometry generally used in the field, such as, but not limited to: a slab, punched sheet, mesh, louver. Preferably, the substrate is made of titanium for its durability, cost and easy surface preparation.

Before applying the active coating, the substrate should, preferably, be cleaned, sandblasted and etched to ensure proper adhesion.

The active coating may be disposed directly over the valve metal substrate, using roller coater, brushing, and spraying techniques. Alternatively, the claimed invention allows an intermediate coating to be interposed between the substrate and the active coating, for example to improve adhesion of the active coating. In this case, the latter shall still be considered disposed over the substrate, albeit indirectly.

Under one embodiment, the catalytic composition of the chlorination electrolyser according to the invention comprises 25%-45% ruthenium and 55%-75% titanium expressed in weight percentage with respect to the elements.

Under another embodiment, the catalytic composition may optionally comprise 2%-5% of doping elements selected from the group consisting of scandium, strontium, hafnium, bismuth, zirconium, aluminium, copper, rhodium, iridium, platinum, palladium and their mutual combinations. These dopants may advantageously contribute to improved lifetime and free available chlorine efficiency of the chlorination electrolyser.

The application of an insulating top coating of tantalum, niobium or tin oxides (combined or separately) on the active coating according to any of the embodiments above allows, for a given lifetime target of the electrode, to reduce the load of Ru up to 38%, without affecting the efficiency.

The reduction of the load of Ru provides a significant advantage because of its scarcity and the consequent procurement and cost issues, especially in comparison with the metal oxides used in the top coating composition of the present invention.

The inventors have found that a top coating of tin oxide works particularly well in the execution of the invention, since Sn appears to form an oxide that allows a better diffusion of Cl⁻ ion to the active layer than Ta or Nb. The Sn top coating also forms a less cracked surface, due to its lower tendency to form dislocations, that cause the typical cracks that can be observed for example on a tantalum oxide surface. A less cracked surface prevents the electrolyte from dissolving the unstable portion of the active layer.

Under a further embodiment, the top coating is preferably sufficiently thin, between 0.5-7 microns, as it may contribute to preserve the free available chlorine (FAC) efficiency of the active layer.

Under any of the embodiments above, the active coating may have a load of ruthenium of 1-30 g/m², which may work both for applications with a salinity above 6 g/l (but preferably below 30 g/l), such as applications for seawater chlorinators, and for applications with salinity below 6 g/l, such as 0.5-4 g/l found in pools.

In pool applications, the top coating has a preferred total load of 2-6 g/m².

Without limiting the invention to a particular theory, the top coating according to the present invention forms a net rather than a barrier: it reduces the mechanical wear of the surface of the active coating due to the friction of the bubbles and retains the material partially dissolved when polarity reversal occurs, thereby preventing delamination of the coating and dissolution of ruthenium and other optional dopants in the electrolyte. At the same time, the porosity and thinness of the top coating allow the electrolyte to reach the catalytic centers of the active coating.

Under another aspect, the invention relates to a self-cleaning electrochlorination system comprising: (i) the chlorinator electrolyser above described; (ii) an electrolyte comprising a 1-30 g/l NaCl brine solution circulating within said electrolyser; (iii) an electronic system for periodically reversing the polarity of the bipolar electrodes of the electrolyser, the electronic system being preferably positioned outside the housing of the electrolyser and electrically connected to the bipolar electrodes.

The electronic system for periodically reversing the polarity of the bipolar electrodes is equipped with an internal clock which allows to reverse the polarity of the bipolar electrodes at preset time intervals, in the range of 30 min-10 hours.

In pool applications, the inventors observed that the self-cleaning electrochlorination system according to the invention performs particularly well when the electronic system inverts the polarity of the bipolar electrode pairs at a preset interval of 1-4 hours.

A stack comprising 5-15 bipolar electrode pairs connected in parallel has been found to be beneficial in the execution of the invention.

The electronic system according to the invention may advantageously operate at a current density of roughly 200-600 A/m², preferably 200-400 A/m².

Under another aspect, the invention relates to a method for the production of the chlorination electrolyser described hereinbefore, comprising the step of manufacturing each electrode of the at least one pair of bipolar electrodes in accordance with the following sequential passages:
a) apply an active coating solution comprising precursors of ruthenium and titanium to a valve metal substrate thus obtaining a coated substrate;
b) bake the coated substrate for 2-10 minutes at a temperature of 450-550° C.;
c) repeat steps a) and b) until achieving the desired load of ruthenium;
d) apply a top coating solution comprising precursors of tantalum, niobium, tin, or combinations thereof to the coated substrate;
e) bake the coated substrate for 2-10 minutes at a temperature of 450-550° C.;
f) repeat steps d) and e) until achieving the desired load of tantalum, niobium, tin or their combination;
g) perform a final thermal treatment at a temperature in the range of 450-550° C.

The precursors of ruthenium and titanium, and the precursors of tantalum, niobium or tin, are compounds selected from the group consisting of methoxides, ethoxides, propoxides, butoxides, chlorides, nitrates, iodides, bromides, sulfates or acetates of the metals and mixtures thereof.

Optionally, after step a) and/or after step d), the coated substrate may be air-dried for 2-10 minutes at a temperature of 20-80° C.

In general, the chlorination electrolyser according to the invention, in particular in regard to the bipolar electrodes architecture, can be successfully employed in all applications for hypochlorite production that undergo polarity reversal, to reduce the noble metal load of the active coating or exhibit extended lifetimes if the same load is applied, without compromising the FAC efficiency.

The inventors have found the chlorination electrolyser to work particularly well in pool applications, operating at a salinity of 0.5-4 g/l.

Under a further aspect, the present invention is directed to the use of the chlorination electrolyser according to the invention in normal and low salinity pools for hypochlorite mediated water disinfection, i.e. for use in pools operating at salt levels equal or below 6 g/l (typically 0.5-2.5 g/l NaCl in low salinity and 2.5-4 g/l NaCl in normal salinity applications).

The following examples are included to demonstrate particular ways of reducing the invention to practice, whose practicability has been largely verified in the claimed range of values.

The present invention also concerns a method for hypochlorite-mediated water disinfection comprising the steps of
a) circulating an electrolyte comprising 1-30 g/l NaCl brine solution within at least one chlorination electrolyser as defined above, said chlorination electrolyser comprising one or more bipolar electrode pairs;
b) applying an electrical current onto said bipolar electrode pairs to produce hypochlorite in said NaCl brine solution;
c) periodically reversing the polarity of the at least one pair of bipolar electrodes during application of said electrical current.

According to one embodiment of the present invention, the polarity of said at least one pair of bipolar electrodes is reversed at time intervals selected from a range of one minute to 20 hours, preferably from a range of 30 min to 10 hours and particularly preferred from a range of 1 to 4 hours.

In a preferred embodiment of the present invention, the electrical current is applied onto said at least one pair of bipolar electrodes at a current density selected from a range of 200 to 600 A/m², preferably from a range of 200 to 400 A/m².

It should be appreciated by those of skill in the art that the equipment, compositions and techniques disclosed in the following represent equipment, compositions and techniques discovered by the inventors to function well in the practice of the invention; however, those of skill in the art should, in light of the present disclosure, appreciate that many changes can be made in the specific embodiments which are disclosed and still obtain a like or similar result without departing from the scope of the invention.

### EXPERIMENT PREPARATION

In all the electrode samples used in the following EXAMPLES and COUNTEREXAMPLE, the valve metal substrate of a pair of bipolar electrodes was manufactured starting from a titanium grade 1 plate of 100 mm×100 mm×1 mm size, degreased with acetone in an ultrasonic bath, and subsequently subject to blasting and full boiling HCl etching at 22% concentration.

The catalytic solution used for the preparation of electrode samples E1, E2a, E2b, and samples C1-C3 was obtained by dissolving chloride salts of ruthenium and titanium in aqueous HCl at 10%, in a ratio of Ru:Ti equal to 28:72 in weight percentage referred to the elements, with a final concentration of ruthenium in each catalytic solution equal to 45 g/l.

The solutions thus prepared were stirred for 30 minutes.

In all electrode samples E1, E2a, E2b, C1-C3, the titanium substrate was coated with the catalytic solution described above, using a brush application with a gain rate of 0.8 g/m² of ruthenium.

After each coating application the samples were baked at a temperature of 500-550° C. for 10 minutes.

The coating procedure above was repeated for each sample E1, E2a, E2b, C1-C3, until achieving a total loading of ruthenium according to TABLE 1 below:

TABLE 1

| SAMPLE | E1 | E2a | E2b | C1 | C2 | C3 |
|---|---|---|---|---|---|---|
| Ru load | 10 | 10 | 12 | 10 | 12 | 16 |
| (g/m²) | | | | | | |

### Example 1

Sample E1 resulting from the EXPERIMENT PREPARATION was further coated with a top coating solution obtained from a Sn acetate solution diluted with acetic acid until reaching a final concentration of 40 g/l. The top coating solution was applied in 4 layers by brush, with a total Sn load of 4.5 g/m². After each layer, the sample was subsequently baked at a temperature of 500-550° C. for 10 minutes.

After the last layer, the sample underwent a post-bake treatment for 3 hours at a temperature of 500-550° C.

Sample electrode E1 was tested according to the following accelerated testing procedure:

A pair of same electrode samples was placed in a housing provided with an inlet and outlet and featured an interelectrodic gap of 3 mm and containing 1 l of an aqueous solution of 4 g/l NaCl and 70 g/l Na₂SO₄ at 25° C.

The electrode pair was operated at a current density of 1000 A/m² and was subject to polarity inversion every 1 minute during the test duration. The electrode pair was kept in testing conditions until cell voltage exceeded 8.5 volt (the “Accelerated Lifetime”, measured in hours for each g/m² of ruthenium in the catalytic composition).

The results are recorded in TABLE 2.

E1 lifetime performance in hours, corresponding to 145 hours online (HOL), was selected as target performance of the bipolar electrodes, as reported in TABLE 2. The FAC of the sample was measured in 3 g/l of NaCl in water at 300 A/m² at temperature of 25° C.

### Example 2

Samples E2, i.e. E2a and E2b, resulting from the EXPERIMENT PREPARATION were both further coated with a top coating solution obtained by dissolving 80 g of TaCl₅ in 1 l of HCl at a 20% concentration and stirring the solution at room temperature for 30 minutes. For each E2 sample, the top coating solution was applied in 1 layer by brush, with a total a Ta load of 1 g/m². The sample was baked first at a temperature of 300-350° C. for 10 minutes and then at a temperature of 500-550° C. for 10 minutes.

Samples E2 were tested according to the same testing procedure described in EXAMPLE 1.

The results of samples E2 were analyzed and the only sample meeting the target performance of E1 was E2b; its performance is characterized in TABLE 2.

### Counterexample 1

Samples C, i.e. C1-C3, resulting from the EXPERIMENT PREPARATION underwent a post-bake treatment for 3 hours at a temperature of 500-550° C. and were tested according to the testing procedure described in EXAMPLE 1.

The results of samples C were analyzed and the only sample meeting the target performance of E1 was C3; its performance is characterized in TABLE 2.

TABLE 2

| Sample | E1 | E2b | C3 |
|---|---|---|---|
| Target lifetime | 100% | 100% | 100% |
| (145 HOL) | | | |
| FAC efficiency | 86% | 85% | 84% |
| Ru load (g/m²) | 10 | 12 | 16 |

The previous description shall not be intended as limiting the invention, which may be used according to different embodiments without departing from the scopes thereof, and whose extent is solely defined by the appended claims.

Throughout the description and claims of the present application, the term “comprise” and variations thereof such as “comprising” and “comprises” are not intended to exclude the presence of other elements, components or additional process steps.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention before the priority date of each claim of this application.

1. A chlorination electrolyser comprising:
a housing provided with an inlet and an outlet suitable for the circulation of brine;
at least one pair of bipolar electrodes facing each other and positioned within said housing;
characterised in that each bipolar electrode of said at least one pair comprises:
a valve metal substrate;
an active coating comprising at least one layer of a catalytic composition comprising ruthenium and titanium disposed over said substrate;
a top coating comprising at least one layer of a composition comprising oxides of tantalum, niobium, tin, or combinations thereof disposed over said active coating.

2. The chlorination electrolyser according to claim 1, wherein said catalytic composition comprises 25%-45% ruthenium and 55%-75% titanium expressed in weight percentage with respect to the elements.

3. The chlorination electrolyser according to claim 2, wherein said catalytic composition further comprises 2%-5% of doping elements selected from the group consisting of scandium, strontium, hafnium, bismuth, zirconium, aluminium, copper, rhodium, iridium, platinum, palladium and their mutual combinations.

4. The chlorination electrolyser according to claim 1, wherein said active coating has a load of ruthenium of 1-30 g/m².

5. The chlorination electrolyser according to claim 1, wherein said top coating consists of tin oxide.

6. The chlorination electrolyser according to claim 1, wherein said top coating has a thickness of 0.5-7 microns.

7. The chlorination electrolyser according to claim 1, wherein said top coating has a total load of 2-6 g/m².

8. The chlorination electrolyser according to claim 1, wherein said valve metal substrate is titanium.

9. A self-cleaning electrochlorination system comprising:
the chlorination electrolyser according to claim 1;
an electrolyte comprising a 1-30 g/l NaCl brine solution circulating within said chlorination electrolyser;
an electronic system for periodically reversing the polarity of the at least one pair of bipolar electrodes and electrically connected thereto.

10. A method for the production of the chlorination electrolyser according to claim 1, comprising the step of manufacturing each electrode of the at least one pair of bipolar electrodes in accordance with the following sequential passages:
a) applying an active coating solution comprising precursors of ruthenium and titanium to a valve metal substrate to obtain a coated substrate;
b) baking the coated substrate for 2-10 minutes at a temperature of 450-550° C.;
c) repeating steps a) and b) until achieving a desired load of ruthenium;
d) applying a top coating solution comprising precursors of tantalum, niobium, tin, or combinations thereof to the coated substrate;
e) baking the coated substrate for 2-10 minutes at a temperature of 450-550° C.;
f) repeat steps d) and e) until achieving a desired load of tantalum, niobium, tin or their combination;
g) performing a final thermal treatment at a temperature in the range of 450-550° C.;
wherein said precursors of ruthenium and titanium and said precursors of tantalum, niobium or tin are compounds selected from the group consisting of methoxides, ethoxides, propoxides, butoxides, chlorides, nitrates, iodides, bromides, sulfates or acetates of the metals and mixtures thereof.

11. A method for hypochlorite mediated water disinfection in normal and low salinity pools comprising using the chlorination electrolyser according to claim 1 in normal and low salinity pools to disinfect water by hypochlorite mediated water disinfection.

12. A method for hypochlorite-mediated water disinfection comprising the steps of
a) circulating an electrolyte comprising 1-30 g/l NaCl brine solution within at least one chlorination electrolyser according to claim 1, said chlorination electrolyser comprising one or more bipolar electrode pairs;
b) applying an electrical current onto said bipolar electrode pairs to produce hypochlorite in said brine solution;
c) periodically reversing the polarity of the at least one pair of bipolar electrodes during application of said electrical current.

13. The method of claim 12, wherein the polarity of said at least one pair of bipolar electrodes is reversed at time intervals selected from a range of 1 minute to 20 hours.

14. The method of claim 12, wherein the electrical current is applied onto said at least one pair of bipolar electrodes pairs at a current density selected from a range of 200 to 600 A/m².
